(19) United States
(12) Patent Application Publication
(10) Pub. No.: US 2026/0332727 A1
(43) Pub. Date: Oct. 22, 2026

(54) CONFERENCE MANAGEMENT METHOD AND CONFERENCE MANAGEMENT APPARATUS

(71) Applicant: Wistron Corporation, New Taipei City (TW)

(72) Inventor: Chien Hsun Wu, New Taipei City (TW)

(73) Assignee: Wistron Corporation, New Taipei City (TW)

(21) Appl. No.: 19/216,560

(22) Filed: May 22, 2025

(30) Foreign Application Priority Data
Apr. 21, 2025 (TW) 114114986

(51) Int. Cl. H04N 7/15; G06N 3/0464; G06Q 10/02; G06Q 30/0645

(52) U.S. Cl. CPC H04N 7/15; G06N 3/0464; G06Q 10/02; G06Q 30/0645

(57) ABSTRACT

A conference management method and a conference management apparatus are provided. In the method, a first conference parameter is obtained. One or a plurality of second conference parameters are generated according to the first conference parameter. A conference is established according to the first conference parameter and the one or plurality of second conference parameters. The first conference parameter is one of a plurality of parameters used to reserve the conference. A relationship between the one or plurality of second conference parameters and the first conference parameter is known. Therefore, suitable parameters can be recommended.

### CROSS-REFERENCE TO RELATED APPLICATION

This application claims the priority benefit of Taiwan application serial no. 114114986, filed on Apr. 21, 2025. The entirety of the above-mentioned patent application is hereby incorporated by reference herein and made a part of this specification.

### BACKGROUND

### Technical Field

The disclosure relates to a scheduling management technology, and particularly relates to a conference management method and a conference management apparatus.

### Description of Related Art

The conference room management systems and remote conferencing software of the related art provide their own functions. The conventional conference room management systems mainly handle the reservation and scheduling of physical conference rooms, but cannot be integrated with remote conferencing functions. For instance, a user cannot directly set up or initiate a remote conference when reserving a conference room.

There are many remote conferencing software available in the market that provide online conference functions, such as Teams, Zoom, etc. However, these software usually operate independently, have different calendars and notification systems, and lack a unified management interface. When a user needs to manage both physical conference rooms and remote conferences simultaneously, the user has to manually operate between different systems, which is inconvenient.

Besides, when a remote conference is conducted in a room equipped with a remote conferencing host, in the practices of the related art, this host often is required to be treated as a separate participant, and a dedicated e-mail has to set up to add the host to the conference invitation. This increases the complexity of operation.

For instance, when a user intends to apply for a conference room with a built-in remote conferencing host, the user needs to first apply for the conference room online, separately sends remote conference invitations, and then remembers to add the remote conferencing host (and its e-mail address) in the conference room to the conference. This manual operation is both time-consuming and error-prone.

Nowadays, some vendors provide both the remote conferencing hosts and conference room management systems. However, these systems can only manage camera device of their own brand most of the time and cannot be integrated with remote conference resources from different brands or software. Even the known remote conferencing software in the market can only manage their own conference notifications and cannot be integrated with physical conference room management systems.

To compensate for operational inconvenience, in the solution of the related art, additional devices such as tablets are set up in conference rooms most of the time, so as to manually input or initiate remote conferences. However, this approach still has limitations. For instance, a remote conferencing host with built-in specific software may not accept conference invitations from other platforms.

In summary, conference room management systems and remote conferencing software of the related art have deficiencies in terms of integration, operational convenience, and device management. When arranging conferences, a user needs to spend much time switching and setting up between different systems, especially in cross-time zone conferences, so time coordination and participant confirmation become increasingly difficult. Information technology (IT) administrators also face challenges such as device management, cost calculation, and information security.

### SUMMARY

The disclosure provides a conference management method and a conference management apparatus capable of integrating a physical conference room with remote conferencing functions, simplify conferencing arrangement processes through intelligent methods, and improving management efficiency of a system.

An embodiment of the disclosure provides a conference management method implemented through a processor. The conference management method includes (but not limited to) the following steps. A first conference parameter is obtained. One or a plurality of second conference parameters are generated according to the first conference parameter. A conference is established according to the first conference parameter and the one or plurality of second conference parameters. The first conference parameter is one of a plurality of parameters used to reserve the conference. A relationship between the one or plurality of second conference parameters and the first conference parameter is known.

An embodiment of the disclosure further provides a conference management apparatus including (but not limited to) a memory and a processor. The memory stores a program code. The processor is coupled to the memory. The processor loads the program code and is configured to obtain a first conference parameter, generate one or a plurality of second conference parameters according to the first conference parameter, and establish a conference according to the first conference parameter and the one or plurality of second conference parameters. The first conference parameter is one of a plurality of parameters used to reserve the conference. A relationship between the one or plurality of second conference parameters and the first conference parameter is known.

To sum up, in the conference management method and the conference management apparatus provided by the embodiments of the disclosure, the second parameter data corresponding to the first conference parameter is determined in a situation where the relationship between parameters is known. Therefore, the user only needs to confirm or select the generated second parameter data to complete the parameter setting operation required for establishing a conference, and operation and management efficiency is thus improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of components of a conference system according to an embodiment of the disclosure.

FIG. 2 is a flow chart of a conference management method according to an embodiment of the disclosure.

FIG. 3 is a schematic view of a conference reservation interface according to an embodiment of the disclosure.

FIG. 4 is a schematic view of a software layer architecture according to an embodiment of the disclosure.

### DESCRIPTION OF THE EMBODIMENTS

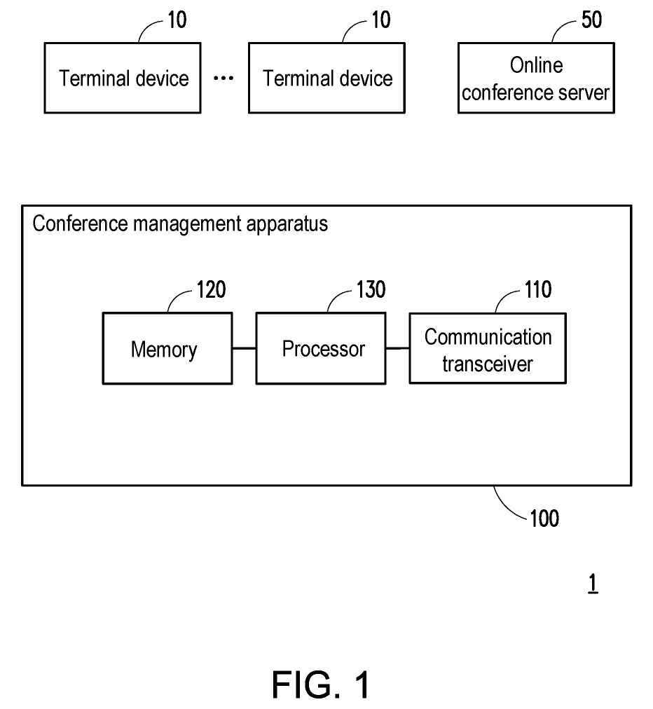

FIG. 1 is a block diagram of components of a conference system 1 according to an embodiment of the disclosure. Referring to FIG. 1, the conference system 1 includes (but not limited to) one or a plurality of terminal devices 10, one or a plurality of online conference servers 50, and a conference management apparatus 100.

The terminal device 10 may be a mobile phone, a desktop computer, a tablet computer, a laptop computer, a voice assistant device, a wearable device, a vehicle system or other electronic apparatuses. In an embodiment, the terminal device 10 has a built-in or connected camera and/or microphone.

The online conference server 50 is a server that may provide conference software (e.g., Teams, Zoom, or Webex) or provide online conference services. For instance, the conference software or web browser running on the terminal device 10 is connected to the online conference server 50 according to conference related information (e.g., URL and/or identifier). The online conference server 50 executes related process, so as to establish or join an online conference session belonging to a conference and provide functions (e.g., forwarding audio, video, and other data) needed for this conference, so as to allow the terminal device 10 to participate in the online conference. The online conference may be a voice or video online conference.

The conference management apparatus 100 may be communicatively connected to the terminal device 10 and the online conference server 50.

The conference management apparatus 100 may be a mobile phone, a desktop computer, a tablet computer, a laptop computer, a voice assistant device, a wearable device, a vehicle system, a workstation system, various types of servers, or other electronic apparatuses.

The conference management apparatus 100 includes (but not limited to) a communication transceiver 110, a memory 120, and a processor 130.

The communication transceiver 110 may be a communication transceiver supporting such as fourth generation (4G) or other generation mobile communication, Wi-Fi, Bluetooth, infrared, radio frequency identification (RFID), Ethernet, optical fiber network, and serial communication interface (e.g., RS-232), and may also be a universal serial bus (USB), Thunderbolt, or other communication transmission interface. In an embodiment, the communication transceiver 110 is used to transmit or receive data with other electronic devices (e.g., the terminal device 10 or the online conference server 50).

The memory 120 may be any type of fixed or removable random access memory (RAM), read only memory (ROM), flash memory, hard disk drive (HDD), solid-state drive (SSD), or similar components. In an embodiment, the memory 120 is used to store codes, software modules, configurations, data (e.g., conference parameters, history data, or model parameters) or files, and details are described in the following embodiments.

The processor 130 may be a central processing unit (CPU), a graphic processing unit (GPU), or a programmable microprocessor for general or special use, a digital signal processor (DSP), a programmable controller, a field programmable gate array (FPGA), an application-specific integrated circuit (ASIC), a neural network accelerator, other similar devices, or a combination of the foregoing devices. In an embodiment, the processor 130 is used to execute all or part of the operations of the conference management apparatus 100 and may load and execute various codes, software modules, files, and data stored in the memory 120. In some embodiments, the functions of the processor 130 may be implemented through software or chips.

In the following paragraphs, a method provided by the embodiments of the disclosure is described together with the various systems, devices, components, and modules in FIG. 1. The flow process of the method may be adjusted according to actual implementation.

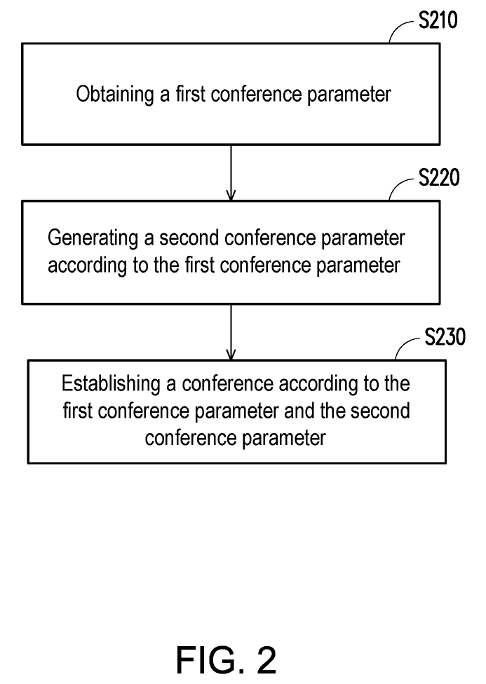

FIG. 2 is a flow chart of a conference management method according to an embodiment of the disclosure. With reference to FIG. 2, the processor 130 obtains a first conference parameter (step S210). To be specific, the first conference parameter is one of a plurality of parameters used to reserve a conference. A type of the first conference parameter may be at least one of a conference subject, participants, time, a conference format, or conference software. The conference subject may be, for example "a specific project of a specific vendor", the participants may be, for example, e-mail addresses, names, nicknames, or identifiers, time maybe, for example, "a specific day of a specific month" or "from 3 o'clock to 6 o'clock", the conference format may be, for example, an online conference or a physical conference, and the conference software may be, for example, Teams, Zoom, or Webex software.

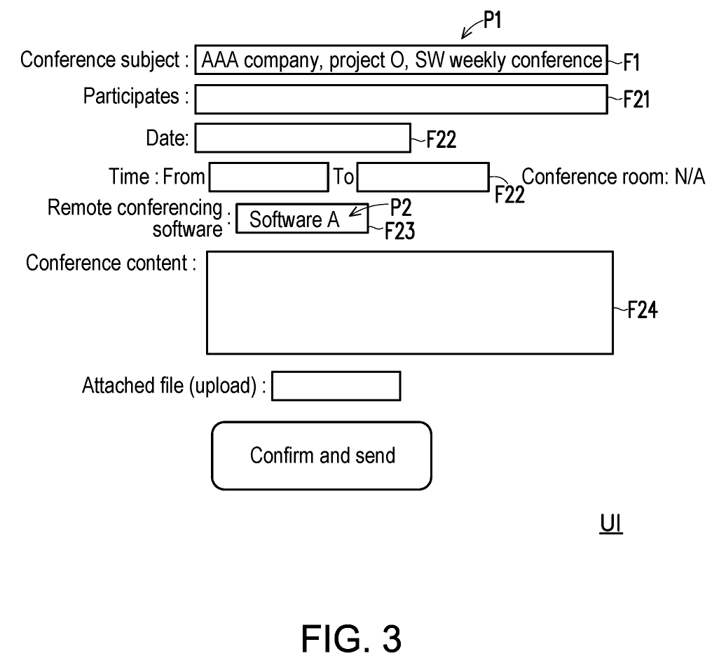

In an embodiment, the processor 130 provides a conference reservation interface. The conference reservation interface includes a first input field corresponding to the first conference parameter. The conference reservation interface is, for example, a conference room rental program (a program for applying for a physical conference) or a user interface provided by other conference applications/reservation programs/software. The conference reservation interface includes a plurality of input fields for a plurality of parameters used to reserve a conference. The input fields may be filled with parameters of corresponding types. For instance, FIG. 3 is a schematic view of a conference reservation interface UI1 according to an embodiment of the disclosure. Referring to FIG. 3, the conference reservation interface UI1 provides a field F1 for "conference subject", a field F21 for "participants", a field F22 for "date/time", a field F23 for "remote conferencing software", and a field F24 for "conference content". A first conference parameter P1 is, for example, "AAA company, project O, SW weekly conference" corresponding to the "conference subject".

The processor 130 may detect the first conference parameter input to the first input field. For instance, the processor 130 detects and receives an input operation (corresponding to the input operation of text content of the first conference parameter) through an input device (e.g., keyboard, mouse, or touch panel), obtains the text content corresponding to this input operation, and sets the first conference parameter as this text content. Alternatively, the processor 130 receives the first conference parameter provided by the terminal device 10 through the communication transceiver 110. The processor 130 analyzes and learns that the received first conference parameter corresponds to the first input field. The terminal device 10 obtains the corresponding text content by detecting and receiving the input operation through the input device.

Referring to FIG. 2, the processor 130 generates one or a plurality of second conference parameters according to the first conference parameter (step S220). To be specific, the second conference parameter is one of the plurality of parameters used to reserve a conference as well. A type of the second conference parameter may be at least one of the conference subject, participants, time, conference format, or conference software as well. In an embodiment, the type of the second conference parameter is different from the type of the first conference parameter. Taking FIG. 3 as an example, the type of the first conference parameter P1 is "conference subject", while a type of the second conference parameter P2 is "remote conference software" (for example, "AA software").

The processor 130 knows a relationship between the one or plurality of second conference parameters and the first conference parameter. In an embodiment, this relationship is obtained through analyzing conference history data. The conference history data may be, for example, record data of past/previous conferences, related data of past/previous conference calendars of the conference room management system/program/software, and/or related data of past/previous conference calendars of e-mail programs or calendar programs. The "past/previous" refers to time points before a reference time point or period. For instance, within 1 year earlier than the current time. The conference history data may be stored in advance in the memory 120. The processor 130 stores the conference history data in corresponding one or plural parameters used to reserve a conference according to identification information of the conference (e.g., number, code, time, or conference subject).

In an embodiment, the processor 130 may input the first conference parameter into a machine learning model and output the second conference parameter through the machine learning model. This machine learning model has learned the relationship between multiple parameters used to reserve a conference. For instance, "Client A" (corresponding to the "participants") has conducted conferences multiple times between "8 to 12 o'clock" (corresponding to "time"), and "Project B" (corresponding to the "conference subject") has been conducted by members of "Department C" (corresponding to the "participants") using "Software D" (corresponding to the "conference software") in "Conference Room E" (corresponding to the "conference format") three times.

For instance, the processor 130 inputs the first conference parameter into a deep learning-based convolutional neural network (CNN) model (i.e., machine learning model). If the first conference parameter is text of the "conference subject", word embedding techniques (e.g., Word2Vec) may be used first to convert it into a sequence of word vectors as the input to the model. This CNN model has been trained through analyzing conference history data from the past year, and the history data includes information such as the conference subject, participants, time, conference format, and remote conferencing software used. The second conference parameter output by the model is the name of the "remote conferencing software" most likely to be used (e.g., "Teams" and "Zoom"). One of the training objectives of the model is to maximize prediction accuracy, and it is regularly fine-tuned with the latest conference records to maintain its prediction accuracy.

It should be noted that in addition to the repetitiveness between multiple parameters in multiple historical/previous/past conferences, the relationship between multiple parameters used for reservation parameters may also be related to the text content in the parameters. For instance, "Client F" is in the United States, and therefore, the "time" associated with "the Client F" corresponds to daytime hours in a specific time zone.

In an embodiment, the parameters used for reserving a conference may be text content. The machine learning model may combine a large language model (LLM) or generative an artificial intelligence model to analyze and understand the meaning of the text content, and helps establish the relationship between multiple parameters.

In an embodiment, the processor 130 may use the conference history data to train the machine learning model. The conference history data includes a plurality of history parameters corresponding to the first conference parameter and the one or plurality of second conference parameters. As described in the foregoing paragraphs, the conference history data may be, for example, record data of the past/previous conferences, related data of the past/previous conference calendars of the conference room management system/program/software, and/or related data of the past/previous conference calendars of e-mail programs or calendar programs. In these data, content corresponding to the types of the first conference parameter and/or the second conference parameter is provided. An algorithm used to train the machine learning model is, for example, an artificial neural network (ANN), support vector regression (SVR), a convolutional neural network (CNN), or other algorithms. During the training process, the machine learning algorithm may adjust a parameter (e.g., weight, bias, or link) in the model according to minimizing a loss function (e.g., a function based on an error between real data and output data). In an initial stage of training the machine learning model, the machine learning model may adopt a predetermined parameter or an initial parameter (e.g., the predetermined or initial weight, bias, or link).

In an embodiment, the processor 130 determines or generates plural second conference parameters of the same type. The processor 130 may assign a priority to each of the second conference parameters. This priority is related to at least one of a weighting index or time. For instance, suitable conferencing times between the other party (client) and us are sorted by time proximity, scheduling is arranged (e.g., global or cross time zones) and overlapping daytime hours across time zones are prioritized, suitable (recommended) participants can be pro-actively provided with an e-mail list for reference, commonly used conference software is prioritized, parameters that meet client's needs are prioritized, and the average conferencing time length (e.g., the time a reserved conference room is used) is prioritized over the longest conferencing time length.

Next, the processor 130 may sort these second conference parameters according to the priorities of these second conference parameters. The second conference parameters with higher priorities are sorted to the front, while the second conference parameters with lower priorities are sorted to the back. After these second conference parameters are sorted, the processor 130 may select one or more second conference parameters ranked at the front as candidate parameters for this type of second conference parameters. The processor 130 may present one or more candidate parameters through a display (e.g., LCD, LED, or OLED) of the terminal device 10 and receive a user operation applied to the terminal device 10 and directed at the selection of candidate parameters.

In an embodiment, the conference reservation interface includes a first input field corresponding to the first conference parameter and one or a plurality of second input fields corresponding to the one or plural second conference parameters. Taking FIG. 3 as an example, the first conference parameter P1 is, for example, "AAA company, project O, SW weekly conference" corresponding to the "conference subject" (located in the field F1). In addition, the second conference parameter P2 is, for example, "Software A" corresponding to the "remote conferencing software" (located in the field F23).

The processor 130 may present the candidate parameters of the one or plural second conference parameters in one or plural second input fields. For instance, for a single second input field, one or plural candidate parameters are presented as a list or checklist. Taking FIG. 3 as an example again, the field F23, in addition to presenting "Software A", may also present other candidate parameters of the same type such as "Software G" and "Software H".

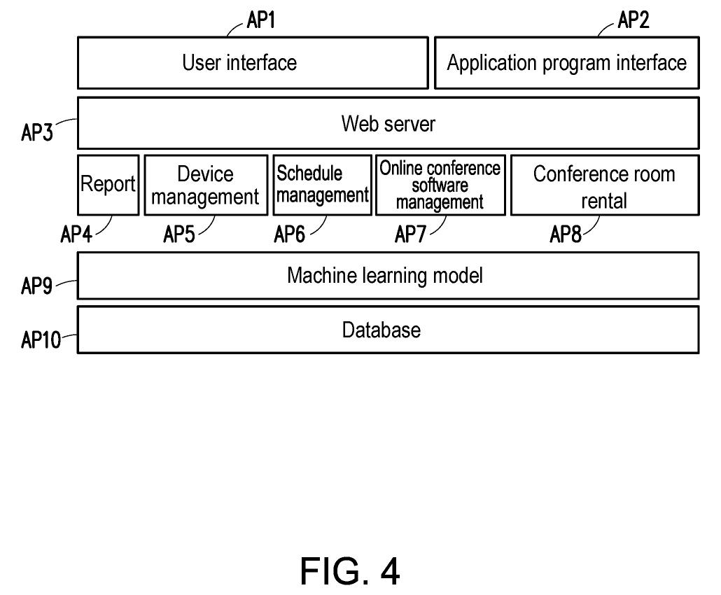

In an embodiment, in the disclosure, various programs/software used for conference reservation may be integrated. For instance, FIG. 4 is a schematic view of a software layer architecture according to an embodiment of the disclosure. Referring to FIG. 4, the conference management apparatus 100 may provide a user interface AP1, an application program interface (API) AP2, a web server AP3, a report program AP4, a device management program AP5, a schedule management program AP6, an online conference software management program AP7, a conference room rental program AP8, a machine learning module AP9, and a database AP10.

The user interface AP1 is, for example, the conference reservation interface UI1 shown in FIG. 3. However, the interface content and design may still be changed according to actual needs.

The application program interface AP2 may allow other programs to access data or issue commands. Alternatively, the terminal device 10 may be connected to and access data of the conference management apparatus 100 through the application program interface AP2.

For the architecture of the web server AP3, it may be implemented through self-built websites within enterprises or companies or through the use of cloud websites. Accordingly, the terminal device 10 may browse the user interface AP1 through a web browser or related application programs. In an embodiment, the web server AP3 is also configured with firewall rules to prevent unauthorized connections. The web server AP3 uses HTTP/HTTPS, Socket, RESTful Web Service, WebAPI, or other standard protocols, for example.

The report program AP4 may report abnormalities or events in the process of establishing a conference.

The device management program AP5 may manage the connection status and/or access permissions of the terminal device 10 connected to the conference management apparatus 100.

The schedule management program AP6 may manage the schedule or calendar of the conference.

The online conference software management program AP7 may manage one or more conference software and be automatically connected to the application program interface of a specific conference software to obtain an online conference link.

The conference room rental program AP8 may manage the rental status and scheduling of physical conference rooms.

The machine learning module AP9, as previously introduced, is used to generate the second conference parameter corresponding to the first conference parameter.

The database AP10 may store, for example, conference history data or other parameters used to reserve/establish a conference.

It should be noted that the types of programs are not limited to those shown in FIG. 4, and other programs may be added or programs shown in FIG. 4 may be decreased as needed.

In an embodiment, the processor 130 may obtain online conference information from at least one of the first conference parameter and the one or plural second conference parameters. The online conference information may be, for example, content of the conference subject, time, conference format, and/or conference software. That is, the type of the first conference parameter or the second conference parameter corresponds to the type of parameters required for conference registration information. The processor 130 may determine the type of the first conference parameter or the second conference parameter and extract the parameters of the corresponding type of online conference information to serve as the online conference information.

Next, the processor 130 may request the corresponding conference software to provide an online conference link for the conference according to the online conference information. For instance, the online conference software management program AP7 calls the application program interface of the selected conference software and provides the online conference information to the online conference server 50 through the application program interface, so as to obtain the corresponding online conference link.

In an embodiment, the processor 130 may obtain the conference registration information from at least one of the first conference parameter and the one or plural second conference parameters. The conference registration information may be, for example, content of the conference subject, time, conference format, and/or conference software. That is, the type of the first conference parameter or the second conference parameter corresponds to the type of parameters required for the conference registration information. The processor 130 may determine the type of the first conference parameter or the second conference parameter and extract the parameters of the corresponding type of conference registration information to serve as the conference registration information.

Next, the processor 130 may request the conference room rental program AP8 to register the conference according to the conference registration information. The conference room rental program AP8 may provide the application program interface or obtain the conference registration information through receiving commands and correspondingly execute procedures such as checking the availability status of a physical conference room, selecting a physical conference room, filling in detailed conference information, submitting a reservation and/or receiving a reservation confirmation.

In an embodiment, the processor 130 may obtain the participant information from at least one of the first conference parameter and the one or plural second conference parameters. The participant information may be e-mail address, name, title, department, and/or number of people. The type of the first conference parameter or the second conference parameter (i.e., participant) corresponds to the type of parameters required for the participant information.

Next, the processor 130 may send an e-mail corresponding to the participant information through the communication transceiver 110. For instance, an e-mail is sent to the e-mail address in the participant information through a mail program, and information such as the online conference link or related attendance information is attached. For another example, the processor 130 searches for the e-mail address corresponding to name, title, or department from the database AP10, and then uses this e-mail address to send an e-mail. For yet another example, after the online conference link is established, the corresponding conference software may directly send an e-mail according to the participant information.

In view of the above, in the conference management method and the conference management apparatus provided by the embodiments of the disclosure, the corresponding second conference parameter may be determined according to the obtained first conference parameter, and the conference may be established accordingly. Therefore, the disclosure provides the following features:
each conference room (space) and remote conferencing host (device) can be easily managed,
costs can be calculated, and expenses are shared,
devices are maintained since the real-time status of each terminal device is known, whether there is a need for repair, remote intervention, or a situation requiring pro-active restart is known,
It will be apparent to those skilled in the art that various modifications and variations can be made to the disclosed embodiments without departing from the scope or spirit of the disclosure. In view of the foregoing,
it is intended that the disclosure covers modifications and variations provided that they fall within the scope of the following claims and their equivalents. information security is improved since whether each remote conferencing host (device) has updated software or has security vulnerabilities is strictly control, and

What is claimed is:

1. A conference management method implemented by a processor, the conference management method comprising:
obtaining a first conference parameter, wherein the first conference parameter is one of a plurality of parameters used to reserve a conference;
generating at least one second conference parameter according to the first conference parameter, wherein a relationship between the at least one second conference parameter and the first conference parameter is known; and
establishing the conference according to the first conference parameter and the at least one second conference parameter.

2. The conference management method according to claim 1, wherein the step of generating the at least one second conference parameter according to the first conference parameter comprises:
inputting the first conference parameter into a machine learning model and outputting the at least one second conference parameter through the machine learning model, wherein the machine learning model has learned the relationship between the parameters.

3. The conference management method according to claim 1, further comprising
training the machine learning model by using conference history data, wherein the conference history data comprises a plurality of history parameters corresponding to the first conference parameter and the at least one second conference parameter.

4. The conference management method according to claim 1, wherein the at least one second conference parameter comprises a plurality of second conference parameters of a same type, and the step of generating the at least one second conference parameter according to the first conference parameter comprises:
assigning a priority to each of the second conference parameters, wherein the priority is related to at least one of a weighting index or time; and
sorting the second conference parameters according to the priorities of the second conference parameters.

5. The conference management method according to claim 1, wherein the step of obtaining the first conference parameter comprises:
providing a conference reservation interface, wherein the conference reservation interface comprises a first input field corresponding to the first conference parameter; and
detecting the first conference parameter input to the first input field.

6. The conference management method according to claim 1, wherein the step of generating the at least one second conference parameter according to the first conference parameter comprises:
providing a conference reservation interface, wherein the conference reservation interface comprises a first input field corresponding to the first conference parameter and at least one second input field corresponding to the at least one second conference parameter; and
presenting a candidate parameter of the at least one second conference parameter in the at least one second input field.

7. The conference management method according to claim 1, wherein the step of establishing the conference according to the first conference parameter and the at least one second conference parameter comprises:
obtaining online conference information from at least one of the first conference parameter and the at least one second conference parameter; and
requesting corresponding conference software to provide an online conference link for the conference according to the online conference information.

8. The conference management method according to claim 1, wherein the step of establishing the conference according to the first conference parameter and the at least one second conference parameter comprises:
obtaining conference registration information from at least one of the first conference parameter and the at least one second conference parameter; and
requesting a conference room rental program to register the conference according to the conference registration information.

9. The conference management method according to claim 1, wherein the step of establishing the conference according to the first conference parameter and the at least one second conference parameter comprises:
obtaining participant information from at least one of the first conference parameter and the at least one second conference parameter; and
sending an e-mail corresponding to the participant information.

10. The conference management method according to claim 1, wherein a type of the first conference parameter and the at least one second conference parameter is at least one of a conference subject, participants, time, a conference format, or conference software.

11. A conference management apparatus, comprising:
a memory storing a program code; and
a processor coupled to the memory, loading the program code, and configured to:
obtain a first conference parameter, wherein the first conference parameter is one of a plurality of parameters used to reserve a conference,
generate at least one second conference parameter according to the first conference parameter, wherein a relationship between the at least one second conference parameter and the first conference parameter is known, and
establish the conference according to the first conference parameter and the at least one second conference parameter.

12. The conference management apparatus according to claim 11, wherein the processor is further configured to:
input the first conference parameter into a machine learning model and output the at least one second conference parameter through the machine learning model.

13. The conference management apparatus according to claim 11, wherein the processor is further configured to:
train the machine learning model by using conference history data, wherein the conference history data comprises a plurality of history parameters corresponding to the first conference parameter and the at least one second conference parameter.

14. The conference management apparatus according to claim 11, wherein the at least one second conference parameter comprises a plurality of second conference parameters of a same type, and the processor is further configured to:
assign a priority to each of the second conference parameters, wherein the priority is related to at least one of a weighting index or time, and
sort the second conference parameters according to the priorities of the second conference parameters.

15. The conference management apparatus according to claim 11, wherein the processor is further configured to:
provide a conference reservation interface, wherein the conference reservation interface comprises a first input field corresponding to the first conference parameter, and
detect the first conference parameter input to the first input field.

16. The conference management apparatus according to claim 11, wherein the processor is further configured to:
provide a conference reservation interface, wherein the conference reservation interface comprises a first input field corresponding to the first conference parameter and at least one second input field corresponding to the at least one second conference parameter, and
present a candidate parameter of the at least one second conference parameter in the at least one second input field.

17. The conference management apparatus according to claim 11, wherein the processor is further configured to:
obtain online conference information from at least one of the first conference parameter and the at least one second conference parameter, and
request corresponding conference software to provide an online conference link for the conference according to the online conference information.

18. The conference management apparatus according to claim 11, wherein the processor is further configured to:
obtain conference registration information from at least one of the first conference parameter and the at least one second conference parameter, and
request a conference room rental program to register the conference according to the conference registration information.

19. The conference management apparatus according to claim 11, further comprising
a communication transceiver coupled to the processor, wherein the processor is further configured to:
obtain participant information from at least one of the first conference parameter and the at least one second conference parameter, and
send an e-mail corresponding to the participant information through the communication transceiver.

20. The conference management apparatus according to claim 11, wherein a type of the first conference parameter and the at least one second conference parameter is at least one of a conference subject, participants, time, a conference format, or conference software.
